(19) United States
(12) Patent Application Publication
(10) Pub. No.: US 2006/0225067 A1
(43) Pub. Date: Oct. 5, 2006

(54) Method for automatically updating and backing up the BIOS

(75) Inventor: Tzu-yi Yang, Taipei (TW)

Correspondence Address: REED SMITH LLP, Suite 1400, 3110 Fairview Park Drive, Falls Church, VA, 22042, US

(73) Assignee: Inventec Corporation

(21) Appl. No.: 11/098,384

(22) Filed: Apr. 5, 2005

(51) Int. Cl. G06F 9/44

(52) U.S. Cl. 717/168

(57) ABSTRACT

A method for automatically updating and backing up the BIOS in data processing devices is prsented. Via a wireless transmission device installed in it, a data processing device receives a BIOS files from an electronic device, and then checks the file's ID code to see if it is correct and is of a latest version. If the BIOS file is correct and is of a latest version, the data processing device will save that BIOS file to its boot up sector and then restart the system to see if the updated BIOS can activate the system in normal working conditions. If the system can be activated, then the BIOS file at the backup sector will also be updated. If the system cannot be activated in normal working conditions, then the BIOS source codes at the backup sector will be copied to the boot sector in order to salvage the BIOS file.

### BACKGROUND OF THE INVENTION

1. Field of the Invention

This invention relates to a method for automatically updating and backing up the BIOS, particularly a method used in data processing devices that uses wireless transmission to update the BIOS.

2. Description of the Related Art

The Basic Input & Output System (BIOS) is a software stored in the Read Only Memory (ROM) of a data processing device. It is required for starting a computer. When a computer is started, its microprocessor will, according to the program settings of the BIOS, first check the mother board, the Video Graphics Array (VGA) cards, and other basic components to see if all these elements work well. Only when the answer is yes will the microprocessor then pass the control of the computer to the operation system and start the standard operation. Through re-writing the BIOS, we can upgrade a computer and its compatibility. Because the BIOS is the very basic structure of a computer or any other data processing devices, it is very important. Any errors in the BIOS will have grave consequences.

When computers and other data processing devices have been used for a period of time, we may have to buy new peripherals (updating CPU, memory . . . etc.) to cope with our need for better operation efficiency or effectiveness. However, after purchasing a new peripheral and installing it on our computer, we often find that the computer does not even find the existence of the newly added peripheral. This is often because your computer's BIOS is of an older version that does not support the new peripheral. We can solve the problem by updating the BIOS.

Aside from the above, manufacturers of data processing devices sometimes come up with new versions of BIOS for their customers to download to remedy existing problems of their products or improve their compatibility,

Conventional way of updating the BIOS is to use CDs or floppy disks that carry updating programs to perform the necessary updating. More recently, thanks to the proliferation of internet users, people can go to the websites of a computer manufacturer to download its latest versions of BIOS file and update their own computer BIOS. But both ways work only for individuals with limited number of computers. If a business or a manufacturer of computers has to do the same updating job to a great number of computers, the above method if obviously far from being satisfactory in terms of efficiency and effectiveness.

### SUMMARY OF THE INVENTION

In view of the foregoing and other problems, disadvantages, and drawbacks of the conventional methods, an object of the present invention is thus to solve the problem of inefficiency confronted by convention ways of BIOS updating. By making use of an electronic device capable of transmitting, through wireless means, the BIOS file to a number of data processing devices within the range of its wireless transmission signals, the method can perform simultaneous BIOS updating to a great number of data processing devices, saving the inconvenience and inefficiency of conventional BIOS updating.

To achieve the above object, the present invention provides a method for automatically updating and backing up the BIOS. Via a wireless transmission device, a data processing device receives a new version BIOS file transmitted by an electronic device to updates its existing BIOS file and make a back up copy. The method comprises the following steps: 1. the data processing device receives a BIOS file via the wireless transmission device; 2. The device checks the BIOS file to see if it is correct; 3. if the BIOS file is correct, the device writes the BIOS's updating codes into the system's boot sector; 4. if the BIOS file is not correct, terminate the BIOS updating process; 5. perform the first boot percedure; 6. if the first boot percedure start the data processing device successfully, the operation system copies the updating codes of the BIOS's boot sector to the BIOS's backup sector; 7. if the first boot procedure fails to start the data processing device, the operation system copies the source codes of the BIOS's backup sector to the system's boot sector; 8. after the operation system has copied the source codes of the BIOS's backup sector to the system's boot sector, perform the second boot procedure.

In the above description, the wireless transmission device can be an infrared transmission device, a wireless transmission device that conforms to the Bluetooth Profile, any wireless transmission device that conforms to WLAN or any radiofrequency communication system. In general practices, when a BIOS file is being transmitted, the BIOS file usually contains, aside from the BIOS's updating codes, a pair of ID codes: a machine ID and a BIOS ID (indicating which version the BIOS is). When the wireless transmission devices used are infrared transmission devices, which is used for one to one transmission, Bluetooth wireless transmission, which can be used for one to as many as 7 transmission, as the devices linked already share common transport specifications and both the transmitting and the receiving devices are already specified, the BIOS file transmitted does not have to contain the machine IDs, but needs only to contain the BIOS ID.

When the wireless transmission devices used are those that conform to Wireless LAN (WLAN) standads or are other RF (radio frequency) transmission systems, the transmission works like broadcasting. That is, so long as the transport protocol between the electronic device and the various data processing devices is the same, a one-to-many transmission can be done simultaneously and, hence, the job of BIOS updating can be conveniently conducted on a number of data processing devices. However, as the data processing devices to receive the updating BIOS file may comprise quite a number of different types, the BIOS file to be transmitted has to contain, aside from the BIOS's updating codes, both the machine ID and the BIOS ID.

To allow transmitting a BIOS file with wireless signals, the invention provide and electronic device that can transmit BIOS files by wireless means. The electronic device includes a memory to store at least a BIOS file, a computing unit to run the BIOS file to be transmitted, a wireless transmission device to transmit the BIOS file designated by the computing unit, and an Input/Output (I/O) port module to be used as an interface between the computing unit and the wireless transmission device.

Through the present invention, at least the following advantages can be obtained.

(a) Via using the invention, one can transmit BIOS file(s) without using cable connection.

(b) Via using the invention, one can update the BIOS files of a great number of data processing devices handily.

(c) Via using the invention, one can update the BIOS files of a great number of data processing devices quickly and simultaneously, without using cable connections.

The present invention will be more fully understood from the detailed description of preferred applications with the aid of the illustrations below.

### BRIEF DESCRIPTOIN OF THE DRAWINGS

FIG. 1 is a diagram of a preferred embodiment of the present invention;

FIG. 2 is a flow chart showing the steps of automatically updating and backing up the BIOS;

FIG. 2A is a flow chart of showing the steps of automatically updating the BIOS;

FIG. 2B is a flow chart showing the steps of automatically backing up and salvaging the BIOS;

FIG. 3 is a diagram of storing the first BIOS file in the electronic device's memory;

FIG. 4 is a diagram of storing the second BIOS file in the electronic device's memory; and

FIG. 5 is a block diagram of a preferred embodiment of the electronic device that can transimit BIOS files via wireless means.

### DETAILED DESCRIPTION OF PREFERRED EMBODIMENT OF THE INVENTION

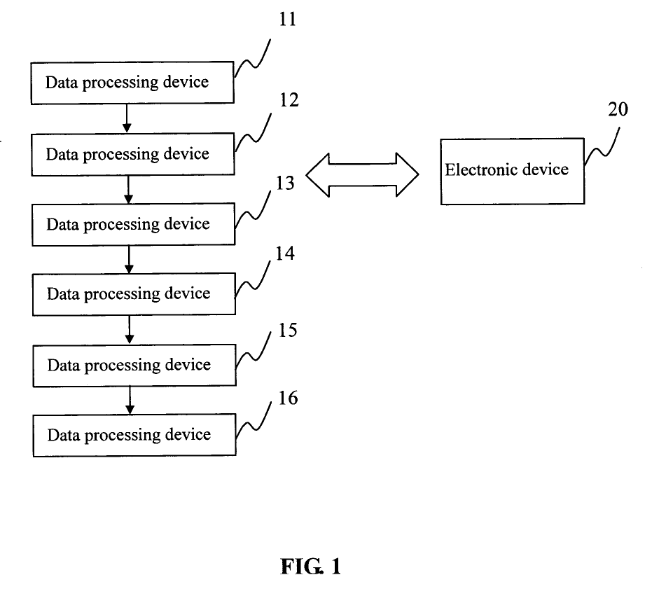

As shown in FIG. 1, a diagram of a preferred embodiment of the present invention, wherein the data processing devices (11,12,13 . . . ) are located within receiving range of wireless transmission signals of the electronic device 20. The plurality of data processing devices (11,12,13 . . . ) can be any kind of data processing devices that have updatable BIOS files, for instances, notebook computers, servers, desktop computers etc., or any data processing devices of the same make but of different models, for instance, Acer's notebook computers TravelMate 3200, TravelMate4000, TravelMate8000, TravelMate370, TravelMate380 . . . etc., HP Integrity servers, rx5670, rx8620, rx76270 . . . etc., Thus when the BIOS files of the above mentioned data processing devices are being updated, discrimination must be made, through a machine ID, among different devices or different models of a device. Even when the devices to be updated are of the same make and the same model, as they may have different versions of BIOS files—for example, Acer TravelMate 3200 may have such different versions of BIOS as 3A01, 3A02, 3A03—discrimination still has to be made among them via the use of a BIOS ID.

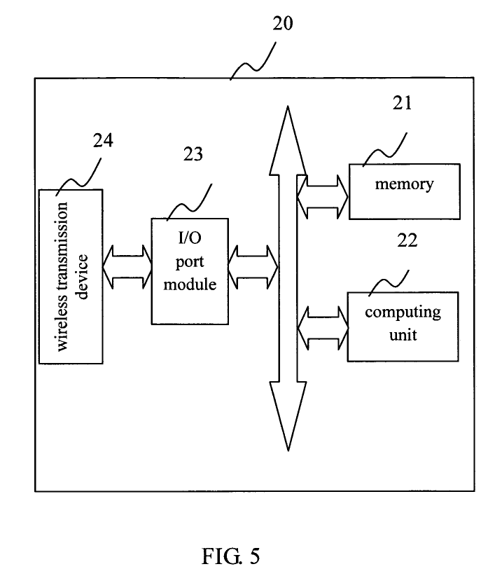

The distance and transmission mode between the data processing devices (11,12,13 . . . ) and the electronic device 20 vary according to the wireless transmission device 24 (shown in FIG. 5) they choose to use. For example, when the wireless transmission device 24 used is an infrared transmission device or a wireless transmission device that conforms to Bluetooth Profile standards, the transmission mode between the two is of a specifically targeted and short-distance nature. When the wireless transmission device 24 used is one that conforms to WLAN or any other RF transmission devices, the transmission mode between the two is of a long-range, indiscrimating, and quasi-broadcasting nature.

Illustrative Preferred Embodiments of the Present Invention's Method of Automatically Updating and Backing up the BIOS

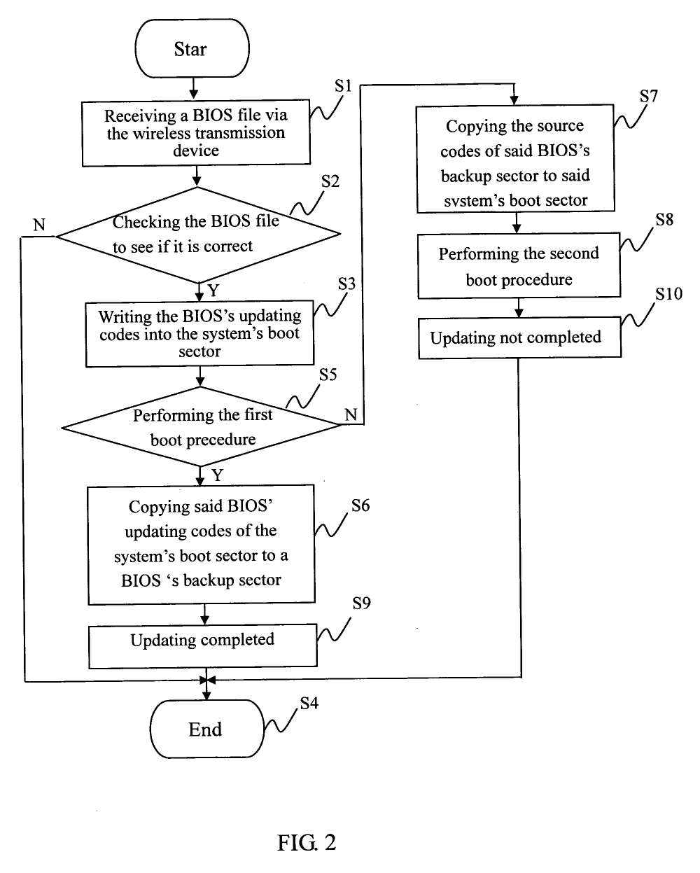

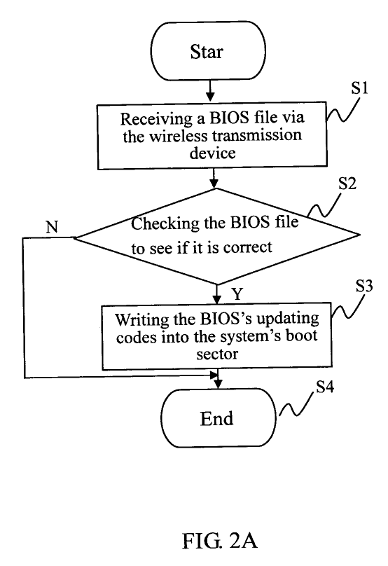

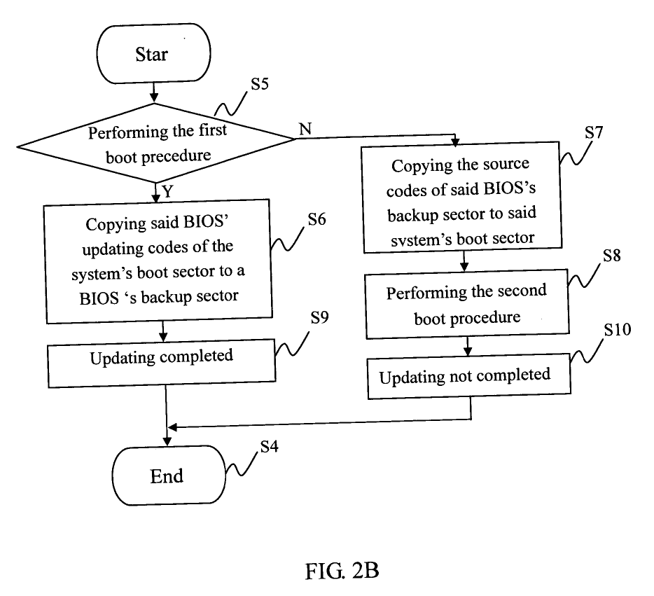

FIG. 2 is a flow chart showing the steps of automatically updating and backing up the BIOS. The method is used in a data processing device. Via a wireless transmission device, a data processing device receives a new version BIOS file transmitted by an electronic device to updates its existing BIOS file and make a back up copy. The method comprises the following steps: 1. the data processing device receives a BIOS file via the wireless transmission device (step 1); 2. The device checks the BIOS file to see if it is correct (step 2); 3. if the BIOS file is correct, the device writes the BIOS's updating codes into the system's boot sector (step 3); 4. if the BIOS file is not correct, terminate the BIOS updating process (step 4); 5. perform the first boot precedure (step 5); 6. if the first boot precedure start the data processing device successfully, the operation system copies the updating codes of the BIOS's boot sector to the BIOS's backup sector (step 6); 7. if the first boot precedure fails to start the data processing device, the operation system copies the source codes of the BIOS's backup sector to the system's boot sector (step 7); 8. after the operation system has copied the source codes of the BIOS's backup sector to the system's bootup sector, perform the second boot procedure (step 8).

In order to let users to know the status of updating process, a step that shows the message “updating completed” (step 9) can be added after the step 6 of copying the updating codes of the BIOS's boot sector to the BIOS's backup sector is completed. On the other hand, a step that shows the message “updating not completed” (step 10) can be added after the step 8 of performing the second boot procedure is completed.

FIG. 2A is a flow chart of showing the steps of automatically updating the BIOS. Via a wireless transmission device, a data processing device receives a new version BIOS file transmitted by an electronic device to updates its existing BIOS file. The process comprises the following steps: 1. the data processing device receives a BIOS file via the wireless transmission device (step 1); 2. The device checks the BIOS file to see if it is correct (step 2); 3. if the BIOS file is correct, the device writes the BIOS's updating codes into the system's boot sector (step 3); 4. if the BIOS file is not correct, terminate the BIOS updating process (step 4);

FIG. 2B is a flow chart showing the steps of automatically backing up and salvaging the BIOS. Via a wireless transmission device, a data processing device receives a new version BIOS file transmitted by an electronic device to updates its existing BIOS file and make a back up copy. After the correctness of the aforementioned BIOS file received is verified, the process to follow comprises the following steps: 5. perform the first boot percedure (step 5); 6. if the first boot percedure start the data processing device successfully, the operation system copies the updating codes of the BIOS's boot sector to the BIOS's backup sector (step 6); 7. if the first boot procedure fails to start the data processing device, the operation system copies the source codes of the BIOS's backup sector to the system's boot sector (step 7); 8. after the operation system has copied the source codes of the BIOS's backup sector to the system's boot sector, perform the second boot procedure (step 8).

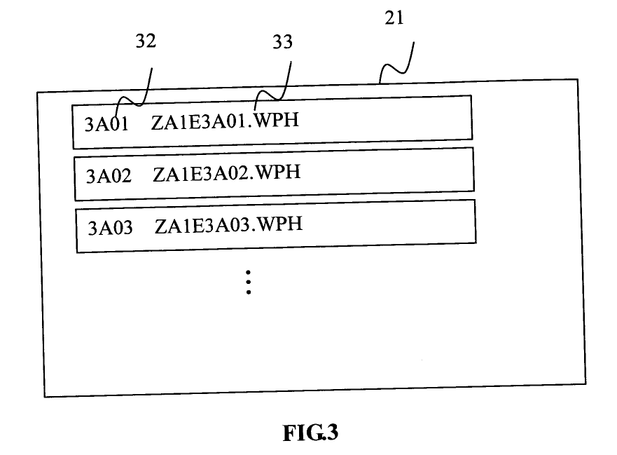

FIG. 3 shows a diagram of storing the first BIOS file in the electronic device's memory. The memory 21 contains at least one set of BIOS file and the electronic device uses a wireless transmission device which is either an infrared transmission device or a wireless transmission device that conforms to the Bluetooth Profile. As when the wireless transmission devices used are infrared transmission devices, which is used for one to one transmission, Bluetooth wireless transmission, which can be used for one to as many as 7 transmission, the devices linked already share common transport specifications and both the transmitting and the receiving devices are already specified, the BIOS file transmitted does not have to contain the machine IDs, but needs only to contain the BIOS ID. Thus, in this example the BIOS file to be transmitted contains an updating code 33 and an ID code 34, which is a BIOS ID 32.

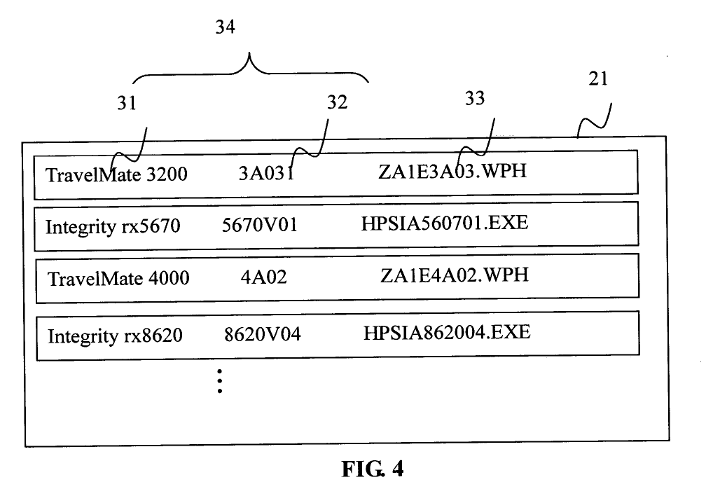

FIG. 4 shows a diagram of storing the second BIOS file in the electronic device's memory. The memory 21 contains at least one set of BIOS file and the electronic device uses a wireless transmission device 24 (shown in FIG. 5) which is either an WLAN device or an RF transmission device. As when the wireless transmission devices 24 used are those that conform to WLAN standads or are other RF transmission systems, the transmission works like broadcasting. That is, so long as the transport protocol between the electronic device 20 and the various data processing devices (11, 12, 13 . . . ) is the same, a one-to-many transmission can be done simultaneously and, hence, the job of BIOS updating can be conveniently conducted on a number of data processing devices. However, as the data processing devices (11, 12, 13 . . . ) to receive the updating BIOS file may comprise quite a number of different types, the BIOS file to be transmitted has to contain, aside from the BIOS's updating codes 33, a set of ID codes 34 which includes a machine ID 31 and a BIOS ID 32.

When doing the BIOS updating described in this preferred emodiment, one can choose a updating BIOS file in the electronic device 20, and transmitted it through a WLAN transmission device. The updating BIOS file includes a machine ID 31, a BIOS ID 32 and a BIOS updating code 33, such as Acer TravelMate 3200, 3A03, ZA1E3A03.WPH. respectively.

When all the data processing devices (11,12,13 . . . ) within the range of the abovementioned wireless transmission device receive the wireless transmission signals, the procedure as illustrated by FIG. 2 in the above will follow, wherein the checking of the BIOS file to see if it is correct as is described in step 2 involoves the checking of the machine code 31 and the BIOS ID 32. Thus only Acer TravelMate 3200 machines whose BIOS versions are older than that of the one being transmitted will undergo the updating. For instance, in this exapmle only those machines whose BIOS versions are 3A01 or 3A02 will be updated (the larger the number, the latest the BIOS version it represents).

If after the checking, the BIOS file is found to be correct, the BIOS updating code 33 will be written into the system's boot sector, completing the BIOS updating process. To ensure the BIOS updating code 33 can function, one will run the first boot precedure to see if the data processing devices (11, 12, 13 . . . ) can start properly. If the answer is yes, it means that the BIOS updating code 33 can function properly. One can then copy the BIOS updating code 33 to a BIOS backup sector. The function of the backup sector is to store a set of correct and executable BIOS codes as a rescue option in case the BIOS updating process fails or that the BIOS codes in the boot sector can't run properly as a result of some unexpected problems.

If the first boot precedure fails, it means that the BIOS updating codes may contain error in it. (e.g. some data are lost during the wireless transmission) At this moment, the system will copy the BIOS codes from the BIOS backup sector to the boot sector as a rescue option. Because BIOS codes in the backup sector have been verified by boot sessions, one can surely complete the second boot procedure without difficulty, thus resuming the normal running of all the data processing devices (11, 12, 13 . . . ).

When the wireless transmission device 24 used in the above is an infrared transmission device or a Bluetooth Profile wireless transmission device, the steps involved are basically the same as those in the above, except that the checking of the BIOS file involves only the checking of the BIOS ID 32, so we will not repeat the same descriptions here.

Illustrative Preferred Embodiment of the Data Processing Device of the Present Invention

FIG. 5 is a block diagram of a preferred embodiment of the electronic device that can transimit BIOS files via wireless means. The electronic device includes a memory 21 to store at least a BIOS file, a computing unit 22 to run the BIOS file to be transmitted, a wireless transmission device 24 to transmit the BIOS file designated by the computing unit 22, and an I/O port module 23 to be used as an interface between the computing unit 22 and the wireless transmission device 24.

The wireless transmission device 24 in the above description can be an infrared transmission device, a Bluetooth Profile wireless transmission device, any wireless transmission device that conforms to WLAN or any RF communication system. Also, the BIOS file can contain an ID code 34 and a BIOS updating code 33, wherein the ID code 34 may further include either a machine ID 31 and a BIOS ID 32 or just a BIOS ID 32, depending on what wireless transmission device 24 one chooses to use.

As is understood by a person skilled in the art, the foregoing preferred application of the present invention is an illustration, rather than a limiting description, of the present invention. It is intended to cover various modifications and similar arrangements included within the spirit and scope of the appended claims, the scope of which should be accorded the broadest interpretation so as to encompass all such modifications and similar structures.

What is claimed is:

1. A method for automatically updating and backing up the BIOS that is used in data processing devices via a wireless transmission device installed in it, a data processing device receives a BIOS files from an electronic device, by which to updates its own BIOS file and also makes a backup copy of said BIOS file; said method comprising the following steps:
receiving a BIOS file via said wireless transmission device;
checking said BIOS file to see if it is correct;
writing the BIOS's updating codes into the system's boot sector if said BIOS file is correct;
terminating the BIOS updating process if said BIOS file is not correct;
performing the first boot precedure;
copying said BIOS' updating codes of said system's boot sector to a BIOS's backup sector if said first boot precedure start the data processing device successfully;
copying the source codes of said BIOS's backup sector to said system's boot sector if said first boot precedure fails to start the data processing device; and
performing the second boot procedure after said source codes of said BIOS's backup sector has been copied to said system's boot sector.

2. The method as claimed in claim 1, wherein said wireless transmission device is an infrared transmission device or a Bluetooth Profile wireless transmission device.

3. The method as claimed in claim 1, wherein said wireless transmission device is a WLAN wireless transmission device.

4. The method as claimed in claim 1, wherein said BIOS file comprises an ID code and a BIOS updating code.

5. The method as claimed in claim 4, wherein said ID code includes a machine ID and a BIOS ID.

6. The method as claimed in claim 4, wherein said ID code is a BIOS ID.

7. The method as claimed in claim 1, wherein, after said step of copying said BIOS' updating codes of said system's boot sector to a BIOS's backup sector is completed, a step that shows the message “updating completed” can be added.

8. The method as claimed in claim 1, wherein, after said step of performing the second boot procedure is completed, a step that shows the message “updating not completed” can be added.

9. A method for automatically updating the BIOS used in data processing devices, wherein, via a wireless transmission device, a data processing device receives a BIOS files from an electronic device, by which to updates its own BIOS file and also makes a backup copy of said BIOS file; said method comprising the following steps:
receiving a BIOS file via said wireless transmission device;
checking said BIOS file to see if it is correct;
writing the BIOS's updating codes into the system's boot sector if said BIOS file is correct; and
terminating the BIOS updating process if said BIOS file is not correct;

10. The method as claimed in claim 9, wherein said wireless transmission device is an infrared transmission device or a Bluetooth Profile wireless transmission device.

11. The method as claimed in claim 9, wherein said wireless transmission device is a WLAN wireless transmission device.

12. The method as claimed in claim 9, wherein said BIOS file comprises an ID code and a BIOS updating code.

13. The method as claimed in claim 12, wherein said ID code includes a machine ID and a BIOS ID.

14. The method as claimed in claim 12, wherein said ID code is a BIOS ID.

15. A method for backing up and salvaging the BIOS, particularly one that is used in an electronic device, which, after having received and verified a correct BIOS file, comprising the following steps:
performing the first boot precedure;
copying said BIOS' updating codes of said system's boot sector to a BIOS's backup sector if said first boot precedure start the data processing device successfully;
copying the source codes of said BIOS's backup sector to said system's boot sector if said first boot precedure fails to start the data processing device; and
performing the second boot procedure after said source codes of said BIOS's backup sector has been copied to said system's boot sector.

16. The method as claimed in claim 15, wherein, after said step of copying said BIOS' updating codes of said system's boot sector to a BIOS's backup sector is completed, a step that shows the message “updating completed” can be added.

17. The method as claimed in claim 15, wherein, after said step of performing the second boot procedure is completed, a step that shows the message “updating not completed” can be added.

18. An electronic device that can transmit BIOS files by wireless means, comprising:
a memory to store at least a set of BIOS file;
a computing unit to run said BIOS file to be transmitted;
a wireless transmission device to transmit said BIOS file designated by said computing unit; and
an I/O port module to be used as an interface between said computing unit and said wireless transmission device.

19. The electronic device as claimed in claim 18, wherein said wireless transmission device is an infrared transmission device or a Bluetooth Profile wireless transmission device.

20. The electronic device as claimed in claim 18, wherein said wireless transmission device is a WLAN wireless transmission device.

21. The electronic device as claimed in claim 18, wherein said BIOS file comprises an ID code and a BIOS updating code.

22. The electronic device as claimed in claim 21, wherein said ID code includes a machine ID and a BIOS ID.

23. The electronic device as claimed in claim 21, wherein said ID code is a BIOS ID.
